(19) United States
(12) Patent Application Publication
(10) Pub. No.: US 2026/0171674 A1
(43) Pub. Date: Jun. 18, 2026

(54) WAVEGUIDE ANTENNA, RADAR, AND AUTOMOBILE

(71) Applicant: SHENZHEN SUNWAY COMMUNICATION CO., LTD., Shenzhen (CN)

(72) Inventors: Ziming He, Shenzhen (CN); Hongwei Liu, Shenzhen (CN)

(21) Appl. No.: 19/530,478

(22) Filed: Feb. 5, 2026

Related U.S. Application Data
(63) Continuation of application No. PCT/CN2024/139203, filed on Dec. 13, 2024.

(30) Foreign Application Priority Data
Apr. 29, 2024 (CN) 202410531607.6

(51) Int. Cl. H01Q 13/00; G01S 7/02; H01Q 1/42

(52) U.S. Cl. CPC H01Q 13/00; G01S 7/027; H01Q 1/42

(57) ABSTRACT

A waveguide antenna includes a housing, a waveguide structure, and a radiation structure. The housing comprises a box body and a cover plate. The waveguide structure is arranged between the box body and the cover plate, and the waveguide structure comprises waveguide channels and resonant cavities. One end of each waveguide channel is opened and is arranged at one end of the housing, and the other end of each waveguide channel is closed and is connected to a resonant cavity. The waveguide channels comprise waveguide grooves, the waveguide grooves are formed on a bottom surface of the box body facing the cover plate, and the cover plate covers groove openings of the waveguide grooves to form the waveguide channels. The radiation structure is arranged on the cover plate and is in communication with the waveguide structure, and the radiation structure is used for transmitting and receiving signals.

### CROSS-REFERENCE TO RELATED APPLICATIONS

This application is a continuation of International Patent Application No. PCT/CN2024/139203, filed on Dec. 13, 2024, which is based upon and claims priority to Chinese Patent Application No. 202410531607.6, filed with the Chinese Patent Office on Apr. 29, 2024 and entitled “A WAVEGUIDE ANTENNA, RADAR AND AUTOMOBILE”, the entirety of which is incorporated herein by reference.

### TECHNICAL FIELD

Embodiments of the present application relate to the technical field of communication, and in particular, relate to a waveguide antenna, a radar and an automobile.

### BACKGROUND

Millimeter Wave (abbreviated as mmWave) refers to electromagnetic wave with frequency between 30 GHz and 300 GHz, and due to advantages of large bandwidth and low air-interface latency, mmWave has been widely used in 5G communication and automotive radar, among other fields. Antenna is one of the core technologies of mmWave communication. Since Professor P. -S. Kildal from Sweden put forward the gap waveguide technology in 2009, gap waveguide antennas with low loss, high integration and simple structure have gradually dominated the mmWave automobile radar antenna market. At present, the gap waveguide antenna mainly adopts a double-layer structure, and the waveguide structure consists of an upper waveguide distributed on the upper substrate and a lower waveguide distributed on the lower substrate.

In the process of implementing the embodiment of the present application, the applicant found that the design of dividing the waveguide structure into an upper waveguide and a lower waveguide which are respectively arranged on the upper substrate and the lower substrate results in a complex structure and a relatively high manufacturing cost.

### SUMMARY

A technical solution adopted in the present application is to provide a waveguide antenna which comprises a housing, a waveguide structure and a radiation structure. The housing comprises a box body and a cover plate, the waveguide structure is arranged between the box body and the cover plate, the waveguide structure is configured to transmit signals; the waveguide structure comprises waveguide channels and resonant cavities, one end of each waveguide channel is opened and is arranged at one end of the housing, the other end of each waveguide channel is closed and is connected to a resonant cavity, the waveguide channels comprise waveguide grooves, the waveguide grooves are formed on a bottom surface of the box body facing the cover plate, the cover plate covers groove openings of the waveguide grooves to form the waveguide channels; the radiation structure is arranged on the cover plate and is in communication with the waveguide structure, and the radiation structure is configured to transmit and receive signals.

Optionally, the longitudinal section of the waveguide channel is of a rectangular shape, and the wide side of the rectangular shape is parallel to the cover plate.

Optionally, the waveguide antenna further comprises a transmission line-waveguide transition structure which is arranged at one end of the housing, one end of the transmission line-waveguide transition structure is arranged in the waveguide channel, and the transmission line-waveguide transition structure is configured to mutually convert and propagate signals between the transmission line and the waveguide antenna.

Optionally, the transmission line-waveguide transition structure comprises an inclined part, a horizontal part and a protruding part which are sequentially connected, wherein the inclined part and the horizontal part are arranged at an end of the surface of the cover plate facing the box body, the inclined part and the horizontal part are located in the waveguide channel, the protruding part protrudes from the edge of the cover plate, the protruding part is used for connecting with the transmission line; the inclined part comprises an inclined plane, and the vertical distance between the inclined plane and the surface of the cover plate increases gradually along the extension direction of the protruding part.

Optionally, the radiation structure comprises a radiation aperture and a radiation groove, wherein the radiation aperture is arranged on the surface of the resonant cavity located on the cover plate, the radiation groove is arranged around the radiation aperture, and the radiation groove is arranged on the surface of the cover plate facing away from the box body.

Optionally, the radiation groove comprises first radiation grooves and second radiation grooves, wherein the first radiation grooves are located at both sides of the resonant cavity, the second radiation grooves are located at one end or both ends of the resonant cavity, and the first radiation groove and the second radiation groove are perpendicular to each other.

Optionally, a connecting groove extends from one end of the box body with a step formed at the starting point of the extension of the connecting groove from the box body, the connecting groove is configured to accommodate the transmission line, the projection of the connecting groove overlaps with the protruding part along the direction in which the cover plate covers the box body, and when the waveguide antenna is connected with the transmission line, one end of the transmission line abuts against the step.

Optionally, the waveguide groove is alternatively arranged on the surface of the cover plate facing the box body, and the bottom surface of the box body covers the groove opening of the waveguide groove to form the waveguide channel.

Another technical solution adopted by the present application is to provide a radar which comprises a circuit board, a radio frequency circuit and the waveguide antenna described above, wherein the waveguide antenna is connected with the radio frequency circuit, and both the waveguide antenna and the radio frequency circuit are arranged on the top of the circuit board.

Another technical solution provided by the present application is to provide an automobile which comprises the radar described above.

### BRIEF DESCRIPTION OF DRAWINGS

In order to more clearly explain technical solutions of embodiments of the present application, attached drawings required in the description of the embodiments of the present application will be briefly introduced hereinafter. Obviously, the attached drawings in the following description are only some embodiments of the present application, and other drawings can be obtained according to these attached drawings by those of ordinary skill in the art without making creative efforts.

FIG. 1 is a perspective view of a waveguide antenna according to an embodiment of the present application.

FIG. 2 is a perspective view of a box body of a waveguide antenna according to an embodiment of the present application.

FIG. 3 is a perspective view of a cover plate of a waveguide antenna according to an embodiment of the present application.

FIG. 4 is a bottom perspective view of a cover plate of a waveguide antenna according to an embodiment of the present application.

FIG. 5 is an enlarged perspective view of a transmission line-waveguide transition structure of a waveguide antenna according to an embodiment of the present application.

FIG. 6 is a perspective view of a box body of a waveguide antenna according to another embodiment of the present application.

FIG. 7 is a bottom perspective view of a cover plate of a waveguide antenna according to another embodiment of the present application.

FIG. 8 is a top view of a microstrip line according to an embodiment of the present application.

FIG. 9 is a partial enlarged view of the connection between the waveguide antenna and the microstrip line according to an embodiment of the present application.

FIG. 10 is an enlarged partial sectional view of the connection between the waveguide antenna and the microstrip line according to an embodiment of the present application.

FIG. 11 is a graph illustrating the return loss of a simulation example of a 1*5 antenna subarray according to an embodiment of the present application.

FIG. 12 is a graph illustrating the total efficiency of a simulation example of a 1*5 antenna subarray according to an embodiment of the present application.

FIG. 13 is a graph illustrating the gain of a simulation example of a 1*5 antenna subarray according to an embodiment of the present application.

FIG. 14 is a schematic view of a radar according to an embodiment of the present application.

### DETAILED DESCRIPTION OF THE INVENTION

In order to facilitate the understanding of this application, this application will be described in more detail with reference to the attached drawings and specific embodiments. It shall be noted that when an element is said to be “fixed to” another element, it may be directly located on the other element, or there may be one or more intervening elements therebetween. When an element is said to be “connected” to another element, it may be directly connected to the other element, or there may be one or more intervening elements therebetween. The terms “vertical”, “horizontal”, “left” and “right” used in this specification and similar expressions are for illustration purposes only.

Unless otherwise defined, all technical and scientific terms used in this specification have the same meaning as commonly understood by those skilled in the technical field of this application. The terminology used in the specification of this application is only for the purpose of describing specific embodiments and is not intended to limit this application. The term “and/or” used in this specification comprises any and all combinations of one or more associated items listed.

Referring to FIG. 1 to FIG. 4, a waveguide antenna 1000 comprises a housing 1, a radiation structure 3, a waveguide structure 2 and a transmission line-waveguide transition structure 4. The waveguide structure 2 and the radiation structure 3 are arranged in the housing 1, the transmission line-waveguide transition structure 4 is arranged at one end of the housing 1, one end of the transmission line-waveguide transition structure 4 is connected with the waveguide structure 2, the other end of the transmission line-waveguide transition structure 4 is used for connecting with an external transmission line, the transmission line-waveguide transition structure 4 is used to mutually convert signals between the transmission line and the waveguide structure 2, the waveguide structure 2 is used for transmitting signals, and the radiation structure 3 is used for transmitting and receiving signals.

Still referring to FIG. 1 to FIG. 4 for the aforesaid housing 1, the housing 1 comprises a box body 11 and a cover plate 12 for covering the box body 11. Along the length direction of the cover plate 12, two limiting plates 121 extend from one end of the cover plate 12, and the two limiting plates 121 are oppositely arranged at edges of two side of the cover plate 12. Along the direction in which the cover plate 12 covers the box body 11, connecting posts 122 extend from the surface of the cover plate 12 facing the box body 11. The box body 11 is provided with a plurality of connecting through holes 110, which are used for connecting posts 122 to pass through to fix the cover plate 12 with the box body 11. A connecting groove 111 extends from one end of the box body 11 with a step 112 formed at the starting point of the extension of the connecting groove 111 from the box body 11. The connecting groove 111 is configured to accommodate the external transmission line, and the projection of the connecting groove 111 overlaps with the limiting plate 121 along the direction in which the cover plate 12 covers the box body 11. When the waveguide antenna 1000 is connected with the external transmission line, one end of the transmission line is arranged in the connecting groove 111, the end face of one end of the transmission line abuts against the step 112, and the limiting plate 121 functions to limit and guide the transmission line.

In some embodiments, the end face of the connecting post 122 is further provided with a connecting hole 120, and when the connecting post 122 passes through the connecting through hole 110 of the box body 11, the connecting hole 120 is engaged with an external device to fix the waveguide antenna 1000 to the external device.

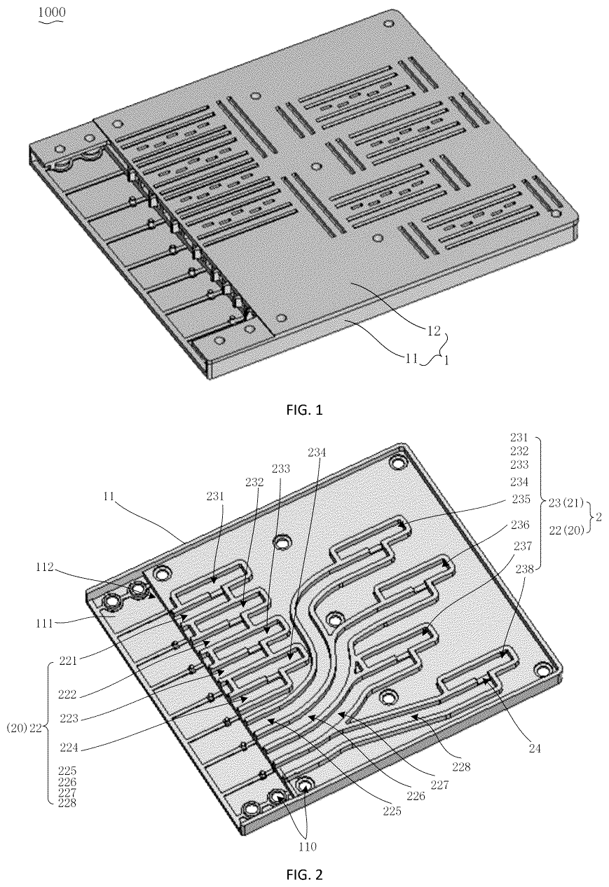

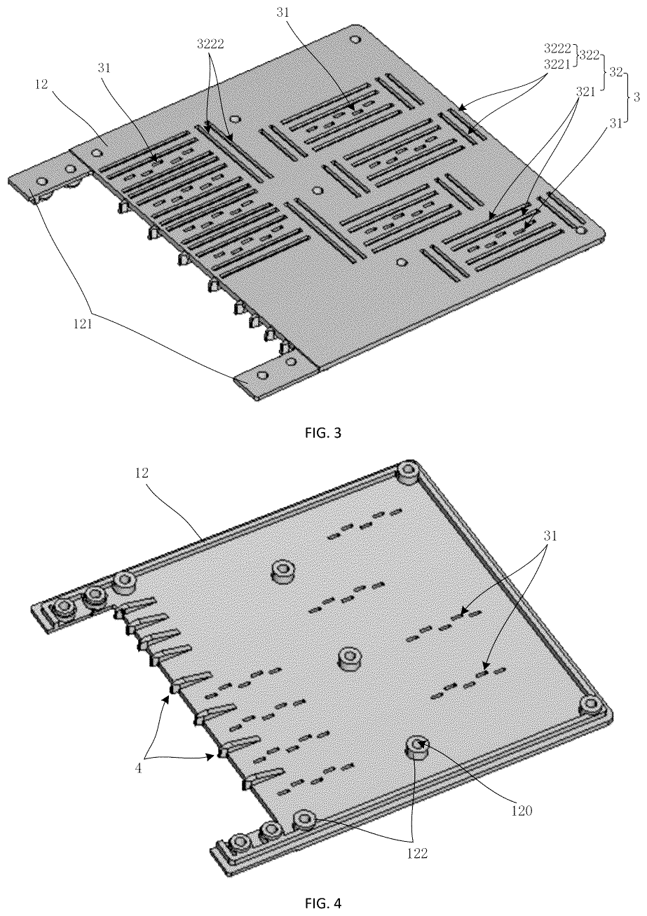

Referring to FIG. 2 and FIG. 3 for the aforesaid waveguide structure 2, the waveguide structure 2 is arranged between the box body 11 and the cover plate 12, and the waveguide structure 2 comprises waveguide channels 20 and resonant cavities 21. The waveguide channels 20 comprise waveguide grooves 22, the waveguide grooves 22 are formed on a bottom surface of the box body 1 facing the cover plate 12, and the cover plate 12 covers groove openings of the waveguide grooves 22 to form the waveguide channels 20. One end of the waveguide channel 20 is opened and is arranged at one end of the housing 1, and the other end of the waveguide channel 20 is closed. The longitudinal section of the waveguide channel 20 is of a rectangular shape, with the wide side of the rectangular longitudinal section parallel to the bottom surface of the box body 11 and the narrow side of the rectangular longitudinal section perpendicular to the bottom surface of the box body 11. The waveguide groove 22 comprises four straight waveguide grooves and four curved waveguide grooves, namely, a first straight waveguide groove 221, a second straight waveguide groove 222, a third straight waveguide groove 223, a fourth straight waveguide groove 224, a first curved waveguide groove 225, a second curved waveguide groove 226, a third curved waveguide groove 227 and a fourth curved waveguide groove 228. The four straight waveguide grooves are arranged in parallel along the width direction of the box body 11, and the four curved waveguide grooves are arranged adjacent to each other at one end and spaced apart from each other at the other end. The cover plate 12 covers the groove openings of the straight waveguide grooves to form the corresponding first, second, third and fourth straight waveguide channels, and the cover plate 12 covers the groove openings of the curved waveguide grooves to form the corresponding first, second, third and fourth curved waveguide channels.

It is worth noting that, as compared to the case where the narrow side of the rectangular longitudinal section is parallel to the bottom surface of the box body 11, the configuration in which the wide side of the rectangular longitudinal section of the waveguide channel 20 is parallel to the bottom surface of the box body 11 results in a smaller height of the waveguide channel and a smaller thickness of the waveguide antenna 1000, which is beneficial to the miniaturization application of the waveguide antenna 1000.

The resonant cavity 21 comprises a concaved groove 23 which is arranged on the bottom surface of the box body 11 facing the cover plate 12, the concaved groove 23 is partially connected with the waveguide groove 22, and the concaved groove 23 is located on one side of the waveguide groove 22. The concaved groove 23 comprises a first concaved groove 231, a second concaved groove 232, a third concaved groove 233, a fourth concaved groove 234, a fifth concaved groove 235, a sixth concaved groove 236, a seventh concaved groove 237 and an eighth concaved groove 238. The cover plate 12 covers the groove opening of the concaved groove 23 to form the corresponding first, second, third, fourth, fifth, sixth, seventh and eighth resonant cavities; the first concaved groove 231, the first straight waveguide groove 221, the second concaved groove 232, the second straight waveguide groove 222, the third concaved groove 233, the third straight waveguide groove 223, the fourth concaved groove 234 and the fourth straight waveguide groove 224 are sequentially arranged adjacently, and the fifth concaved groove 235, the sixth concaved groove 236, the seventh concaved groove 237 and the eighth concaved groove 238 are respectively arranged at one side of the other end of the first curved waveguide groove 225, the second curved waveguide groove 226, the third curved waveguide groove 227 and the fourth curved waveguide groove 228.

In the embodiment of the present application, the number of waveguide channels 20 and corresponding resonant cavities 21 is eight, and the side wall of a waveguide channel 20 connected with a resonant cavity 21 is provided with a coupling hole 24 for coupling electromagnetic waves of the waveguide channel 20 to the resonant cavity 21.

Referring to FIG. 3 and FIG. 4 for the above-mentioned radiation structure 3, the radiation structure 3 is arranged on the surface of the cover plate 12 facing away from the box body 11, and the radiation structure 3 comprises radiation apertures 31 and radiation grooves 32. The radiation apertures 31 are arranged on the surface of the resonant cavity 21 located on the cover plate 12, and the radiation apertures 31 are in communication with the resonant cavity 21 for realizing the signal transmission between the resonant cavity 21 and the external environment. Each resonant cavity 21 corresponds to five radiation apertures 31, and the five radiation apertures 31 are distributed in a staggered manner on both sides of the centerline along the length direction of a resonant cavity 21. The radiation grooves 32 are arranged around the radiation apertures 31, and the radiation grooves 32 are used for broadening the radiation beam. The radiation grooves 32 include a first radiation groove 321 and a second radiation groove 322. The first radiation groove 321 is located at both sides of the resonant cavity 21, and the second radiation groove 322 is located at one end or both ends of the resonant cavity 21. The first radiation groove 321 and the second radiation groove 322 are perpendicular to each other, and the second radiation groove 322 comprises a first horizontal radiation groove 3221 and a second horizontal radiation groove 3222 arranged in parallel along the width direction of the cover plate 12.

In the embodiment of the present application, the specific distribution of the radiation grooves 32 is as follows: two first radiation grooves 321 are distributed on each of both sides of the fifth resonant cavity, the sixth resonant cavity and the eighth resonant cavity, and two first horizontal radiation grooves 3221 are distributed on each of both ends of the fifth resonant cavity, the sixth resonant cavity and the eighth resonant cavity. Two sides of the seventh resonant cavity are each provided with two first radiation grooves 321, and one end of the seventh resonant cavity is provided with two first horizontal radiation grooves 3221. Two first radiation grooves 321 are arranged on each of one side of the first resonant cavity and one side of the fourth resonant cavity, and three first radiation grooves 321 are arranged between any adjacent pairs of the first resonant cavity, the second resonant cavity, the third resonant cavity and the fourth resonant cavity. One end of the first resonant cavity, the second resonant cavity, the third resonant cavity and the fourth resonant cavity is close to the edge of one end of the box body 11, the other end thereof is provided with two groups of second horizontal radiation grooves 3222, and the number of each group of second horizontal radiation grooves 3222 is two. At the same time, one group of second horizontal radiation grooves 3222 is located at the other end of the seventh resonant cavity.

It should be noted that the arrangement of the radiation apertures 31 and the radiation grooves 32 described above makes the radiation pattern of each resonant cavity 21 symmetrical about the centerline in the length direction of the resonant cavity 21.

As shall be appreciated, the waveguide structure 2 and the radiation structure 3 are not limited to the above description. In different embodiments, the shape and number of waveguide channels 20 may be set differently according to actual needs, the number of resonant cavities 21 is matched with that of waveguide channels 20, and the shape and number of radiation apertures 31 and radiation grooves 32 may also be set differently according to actual needs.

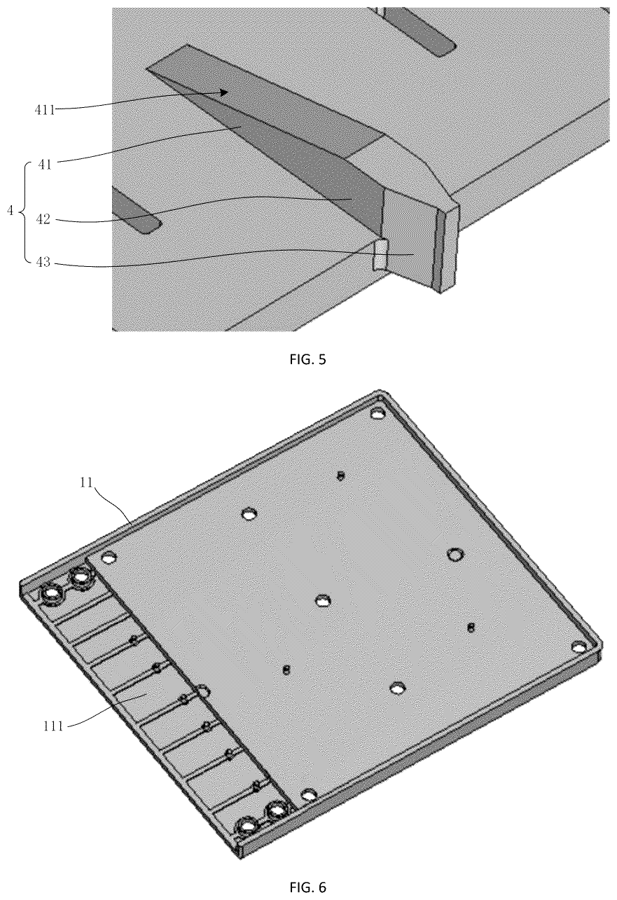

Referring to FIG. 4 and FIG. 5 for the aforesaid transmission line-waveguide transition structure 4, the transmission line-waveguide transition structure 4 is arranged in a waveguide channel 20, and the transmission line-waveguide transition structure 4 comprises an inclined part 41, a horizontal part 42 and a protruding part 43 which are sequentially connected. The inclined part 41 and the horizontal part 42 are arranged at an end of the surface of the cover plate 12 facing the box body 11, the inclined part 41 and the horizontal part 42 are located in the waveguide channel 20, the joint of the horizontal part 42 and the protruding part 43 is located at the edge of the cover plate 12, and the protruding part 43 protrudes from the edge of the cover plate 12. Along the direction in which the cover plate 12 covers the box body 11, the projection of the protruding part 43 overlaps with the connecting groove 111, and the protruding part 43 is used for abutting connection with the transmission line. The inclined part 41 comprises an inclined plane 411, and the vertical distance between the inclined plane 411 and the surface of the cover plate 12 increases gradually along the extending direction of the protruding part 43.

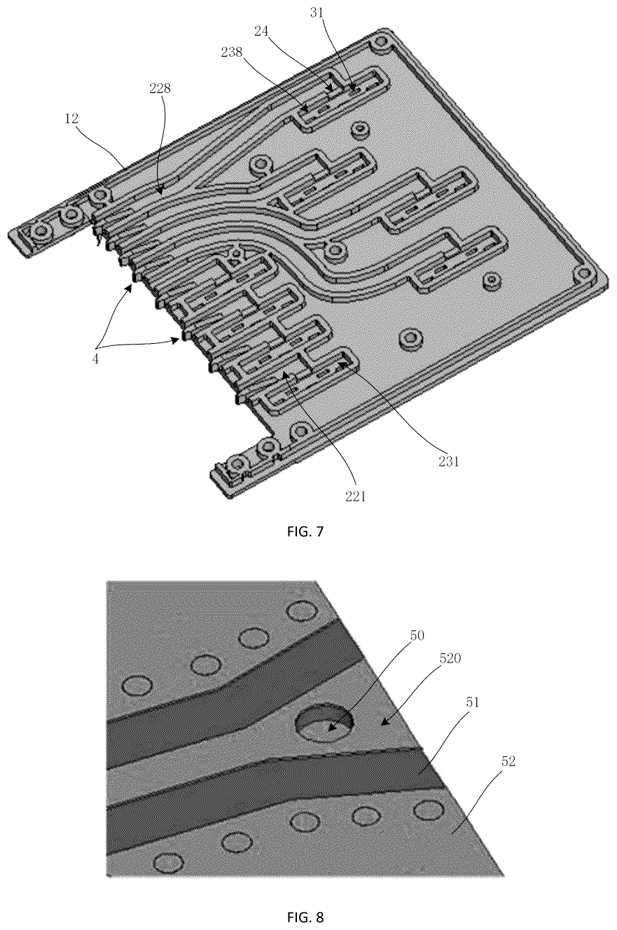

In some embodiments, the structure of the waveguide antenna 1000 is not limited to the above description, but may also be other structures. For example, referring to FIG. 6 and FIG. 7, the specific structures of the housing 1, the radiation structure 3 and the transmission line-waveguide transition structure 4 are the same as the above structures, while the waveguide groove 22 and the concaved groove 23 in the waveguide structure 2 are arranged on the surface of the cover plate 12 facing the box body 11, the bottom surface of the box body 11 covers the groove opening of the waveguide groove 22 to form the waveguide channel 20, and the bottom surface of the box body 11 covers the groove opening of the concaved groove 23 to form the resonant cavity 21.

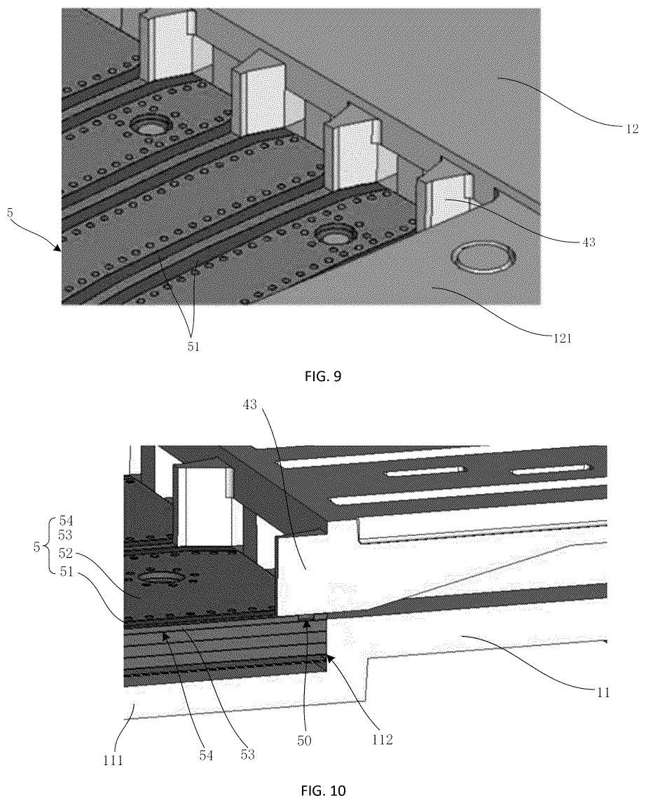

In some embodiments, referring to FIG. 8 to FIG. 10, the transmission line is a microstrip line 5. When the microstrip line 5 is connected to the waveguide antenna 1000, one end of the microstrip line 5 is provided in the connecting groove 111, the end face of one end of the microstrip line 5 abuts against the step 112, and the limiting plate 121 functions to limit and guide the connection of the microstrip line 5. The microstrip line 5 comprises conductor strips 51, a first metal layer 52, a substrate 53 and a second metal layer 54, wherein the substrate 53 is arranged between the first metal layer 52 and the second metal layer 54, and the conductor strips 51 are embedded in the first metal layer 52. A transition zone 520 is arranged between the two conductor strips 51, and the shape of the transition zone 520 matches the projection shape of the protruding part 43 along the direction in which the cover plate 12 covers the box body 11. An air hole 50 is further provided at the middle of the transition zone 520, the air hole 50 penetrates through the first metal layer 52 and the substrate 53 without penetrating through the second metal layer 54, and the air hole 50 is used to realize the impedance matching during the transition from the microstrip line 5 to the waveguide channel 20. The spacing from the protruding part 43 to the bottom surface of the waveguide channel 20 is equal to the thickness of the substrate 53, the second metal layer 54 is located at the same horizontal plane with the bottom surface of the waveguide channel 20, and the second metal layer 54 contacts the edge of the opening end of the waveguide channel 20.

In some embodiments, the projection shape of the protruding part 43 along the direction in which the cover plate 12 covers the box body 11 is a triangle or a trapezoid resembling a triangle, and the shape of the transition zone 520 is correspondingly a triangle or a trapezoid resembling a triangle.

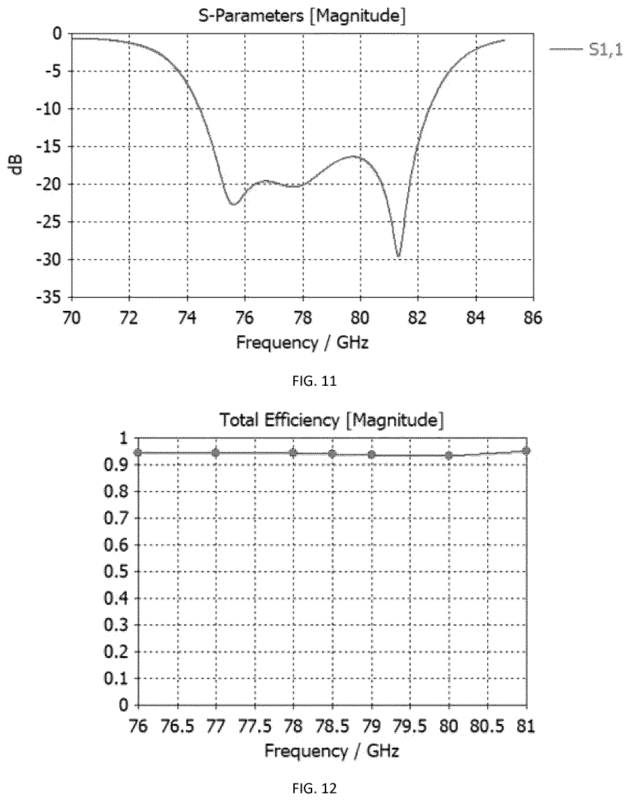

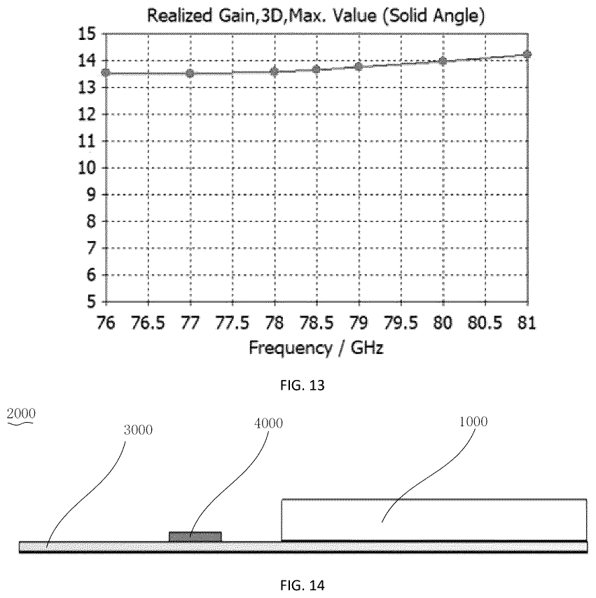

In order to facilitate understanding, the present application further provides a simulation experimental embodiment, which uses the CST microwave simulation software to perform simulation calculations on a 1*5 antenna subarray employing the aforementioned waveguide antenna 1000 as the antenna unit. A 50 ohm standard microstrip line is selected as the microstrip line 5. Along the length direction of the box body 11, the length of the connecting groove 111 is 12 mm, the sum of the length of the inclined part 41 and the length of the horizontal part 42 is 5.9 mm, the length of the horizontal part 42 is 1 mm, the length of the protruding part 43 is 1.2 mm, the radius of the air through hole is 0.2 mm, the distance from the center of the air hole 50 to the edge of the first metal layer 52 is 0.5 mm, and the length of the transition zone 520 is 1 mm. The size of the radiation aperture 31 is 1.9 mm*0.475 mm, both the size of the first radiation groove 321 and the size of the second horizontal radiation groove 3222 are 17.28 mm*0.75 mm*0.6 mm, and the size of the first horizontal radiation groove 3221 is 8.59 mm*0.75 mm*0.6 mm. Referring to FIG. 11 to FIG. 13 for the simulation results, FIG. 11 is a graph illustrating the return loss of this simulation experimental embodiment, FIG. 12 is a graph illustrating the total efficiency of this simulation experimental embodiment, and FIG. 13 is a graph illustrating the peak gain of this simulation experimental embodiment. It can be concluded that the bandwidth range of return loss below −15 dB is 75-82 GHz, the total efficiency in the frequency band of 76-81 GHz is greater than 93%, and the peak gain in the frequency band of 76-81 GHz is +13.5 to +14.2 dBi. Therefore, the waveguide antenna of the present application has the characteristics of low loss, high efficiency and high gain in the frequency band of 77G (76-81 GHz).

It shall be noted that in the above-mentioned simulation experimental embodiment, the structure of the waveguide antenna may be as shown in FIG. 2 to FIG. 4 in which the waveguide groove 22 and the concaved groove 23 are arranged on the bottom surface of the box body 11 facing the cover plate 12, or the structure of the waveguide antenna may be as shown in FIG. 6 and FIG. 7 in which the waveguide groove 22 and the concaved groove 23 are arranged on the surface of the cover plate 12 facing the box body 11.

As shall be appreciated, the above simulation experimental embodiment focuses on the frequency band of 76-81 GHz, but the waveguide antenna 1000 in the present application is also applicable to other mmWave bands, such as 5G mmWave (24-53 GHz) and satellite communication bands (Ku, Ka).

In the embodiment of the present application, the waveguide antenna 1000 comprises a housing 1, a waveguide structure 2, a radiation structure 3 and a transmission line-waveguide transition structure 4, wherein the housing 1 comprises a box body 11 and a cover plate 12 for covering the box body 11, the waveguide structure 2 comprises waveguide channels 20 and resonant cavities 21, the waveguide channels 20 comprise waveguide grooves 22, the resonant cavities 21 comprise concaved grooves 23, the waveguide grooves 22 and the concaved grooves 23 are arranged on the bottom surface of the box body 11 facing the cover plate 12, and the cover plate 12 covers the groove openings of the waveguide grooves 22 and the concaved grooves 23 to form the waveguide channels 20 and the resonant cavities 21. The radiation structure 3 comprises a radiation aperture 31 and a radiation groove, the radiation aperture 31 is arranged on the surface of the resonant cavity 21 located on the cover plate 12 and is in communication with the resonant cavity 21, the radiation groove 32 is provided on the surface of the cover plate 12 facing away from the box body 11, and the radiation groove 32 is arranged around the radiation aperture 31. One end of the transmission line-waveguide transition structure 4 is arranged in the waveguide channel 20, and the other end of the transmission line-waveguide transition structure 4 protrudes from the housing 1. The signal of the transmission line is transmitted into the waveguide channel 20 through the transmission line-waveguide transition structure 4, and then transmitted to the resonant cavity 21 through the waveguide channel 20 and radiated by the radiation aperture 31 for propagation, and the radiation groove 32 is used for broadening the radiation beam. The waveguide groove 22 and the concaved groove 23 of the waveguide structure 2 are only arranged on the bottom surface of the box body 11, and only the box body 11 needs to be processed for the manufacturing of the waveguide structure 2, so that the structure is simple and the manufacturing cost is low.

The present application further provides an embodiment of a radar 2000. Referring to FIG. 14, the radar 2000 comprises a circuit board 3000, a radio frequency circuit 4000 and the aforesaid waveguide antenna 1000. Both the waveguide antenna 1000 and the radio frequency circuit 4000 are arranged on the top of the circuit board 3000, the waveguide antenna 1000 is connected with the radio frequency circuit 4000, the connecting post 122 of the cover plate 12 of the waveguide antenna 1000 passes through the connecting through hole 110 of the box body 11, and the connecting hole 120 of the connecting post 122 is engaged with the circuit board 3000 to fix the waveguide antenna 1000 to the circuit board 3000. Reference may be made to the above-mentioned embodiments for the structure and function of the waveguide antenna 1000, and this will not be further described herein.

In the embodiment of the present application, both the waveguide antenna 1000 and the radio frequency circuit 4000 of the radar 2000 are arranged at the top of the circuit board 3000, and thus as compared to the case where the waveguide antenna and the radio frequency circuit are arranged at the top and bottom of the circuit board respectively, the signal connection between the waveguide antenna 1000 and the radio frequency circuit 4000 of the present application is simpler, which is beneficial to reducing the manufacturing cost. Moreover, the signal line is shorter with less interference, thereby reducing the loss of signal transmission.

The present application further provides an embodiment of an automobile. Referring to the figure, the automobile comprises the above-mentioned radar 2000. Reference may be made to the above-mentioned embodiments for the structure and function of the radar 2000, and this will not be further described herein.

It shall be noted that the specification and attached drawings of the present application give preferred embodiments of the present application, but the present application can be realized in many different forms and is not limited to the embodiments described in this specification. These embodiments do not serve as additional restrictions on the contents of the present application, and the purpose of providing these embodiments is to make the understanding of the disclosure of the present application more thorough and comprehensive. Moreover, the above technical features continue to be combined with each other to form various embodiments not listed above, which are all regarded as within the scope recorded in the specification of the present application. Furthermore, improvements or transformations can be made according to the above description by those of ordinary skill in the art, and all these improvements and transformations shall belong to the scope claimed in the appended claims of the present application.

1. A waveguide antenna, comprising:
a housing, comprising a box body and a cover plate;
a waveguide structure, being arranged between the box body and the cover plate and being configured to transmit signals, the waveguide structure comprising waveguide channels and resonant cavities, wherein one end of each waveguide channel is opened and is arranged at one end of the housing, the other end of each waveguide channel is closed and is connected to a resonant cavity, the waveguide channels comprise waveguide grooves, the waveguide grooves are formed on a bottom surface of the box body facing the cover plate, the cover plate covers groove openings of the waveguide grooves to form the waveguide channels; and
a radiation structure, being arranged on the cover plate and being in communication with the waveguide structure, wherein the radiation structure is configured to transmit and receive signals.

2. The waveguide antenna according to claim 1, wherein the longitudinal section of the waveguide channel is of a rectangular shape, and the wide side of the rectangular shape is parallel to the cover plate.

3. The waveguide antenna according to claim 1, wherein the waveguide antenna further comprises a transmission line-waveguide transition structure which is arranged at one end of the housing, one end of the transmission line-waveguide transition structure is arranged in the waveguide channel, and the transmission line-waveguide transition structure is configured to mutually convert and propagate signals between the transmission line and the waveguide antenna.

4. The waveguide antenna according to claim 3, wherein the transmission line-waveguide transition structure comprises an inclined part, a horizontal part and a protruding part which are sequentially connected, wherein the inclined part and the horizontal part are arranged at an end of the surface of the cover plate facing the box body, the inclined part and the horizontal part are located in the waveguide channel, the protruding part protrudes from the edge of the cover plate, and the protruding part is used for connecting with the transmission line;
the inclined part comprises an inclined plane, and the vertical distance between the inclined plane and the surface of the cover plate increases gradually along the extension direction of the protruding part.

5. The waveguide antenna according to claim 1, wherein the radiation structure comprises a radiation aperture and a radiation groove, wherein the radiation aperture is arranged on the surface of the resonant cavity located on the cover plate, the radiation groove is arranged around the radiation aperture, and the radiation groove is arranged on the surface of the cover plate facing away from the box body.

6. The waveguide antenna according to claim 5, wherein the radiation groove comprises first radiation grooves and second radiation grooves, wherein the first radiation grooves are located at both sides of the resonant cavity, the second radiation grooves are located at one end or both ends of the resonant cavity, and the first radiation groove and the second radiation groove are perpendicular to each other.

7. The waveguide antenna according to claim 4, wherein a connecting groove extends from one end of the box body with a step formed at the starting point of the extension of the connecting groove from the box body, the connecting groove is configured to accommodate the transmission line, the projection of the connecting groove overlaps with the protruding part along the direction in which the cover plate covers the box body, and when the waveguide antenna is connected with the transmission line, one end of the transmission line abuts against the step.

8. The waveguide antenna according to claim 1, wherein the waveguide groove is arranged on the surface of the cover plate facing the box body, and the bottom surface of the box body covers the groove opening of the waveguide groove to form the waveguide channel.

9. A radar, comprising a circuit board, a radio frequency circuit and a waveguide antenna, wherein the waveguide antenna is connected with the radio frequency circuit, and both the waveguide antenna and the radio frequency circuit are arranged on the top of the circuit board;
wherein the waveguide antenna comprises:
a housing, comprising a box body and a cover plate;
a waveguide structure, being arranged between the box body and the cover plate and being configured to transmit signals, the waveguide structure comprising waveguide channels and resonant cavities, wherein one end of each waveguide channel is opened and is arranged at one end of the housing, the other end of each waveguide channel is closed and is connected to a resonant cavity, the waveguide channels comprise waveguide grooves, the waveguide grooves are formed on a bottom surface of the box body facing the cover plate, the cover plate covers groove openings of the waveguide grooves to form the waveguide channels; and
a radiation structure, being arranged on the cover plate and being in communication with the waveguide structure, wherein the radiation structure is configured to transmit and receive signals.

10. The radar according to claim 9, wherein the longitudinal section of the waveguide channel is of a rectangular shape, and the wide side of the rectangular shape is parallel to the cover plate.

11. The radar according to claim 9, wherein the waveguide antenna further comprises a transmission line-waveguide transition structure which is arranged at one end of the housing, one end of the transmission line-waveguide transition structure is arranged in the waveguide channel, and the transmission line-waveguide transition structure is configured to mutually convert and propagate signals between the transmission line and the waveguide antenna.

12. The radar according to claim 11, wherein the transmission line-waveguide transition structure comprises an inclined part, a horizontal part and a protruding part which are sequentially connected, wherein the inclined part and the horizontal part are arranged at an end of the surface of the cover plate facing the box body, the inclined part and the horizontal part are located in the waveguide channel, the protruding part protrudes from the edge of the cover plate, and the protruding part is used for connecting with the transmission line;
the inclined part comprises an inclined plane, and the vertical distance between the inclined plane and the surface of the cover plate increases gradually along the extension direction of the protruding part.

13. The radar according to claim 1, wherein the radiation structure comprises a radiation aperture and a radiation groove, wherein the radiation aperture is arranged on the surface of the resonant cavity located on the cover plate, the radiation groove is arranged around the radiation aperture, and the radiation groove is arranged on the surface of the cover plate facing away from the box body.

14. The radar according to claim 13, wherein the radiation groove comprises first radiation grooves and second radiation grooves, wherein the first radiation grooves are located at both sides of the resonant cavity, the second radiation grooves are located at one end or both ends of the resonant cavity, and the first radiation groove and the second radiation groove are perpendicular to each other.

15. The radar according to claim 12, wherein a connecting groove extends from one end of the box body with a step formed at the starting point of the extension of the connecting groove from the box body, the connecting groove is configured to accommodate the transmission line, the projection of the connecting groove overlaps with the protruding part along the direction in which the cover plate covers the box body, and when the waveguide antenna is connected with the transmission line, one end of the transmission line abuts against the step.

16. The radar according to claim 9, wherein the waveguide groove is arranged on the surface of the cover plate facing the box body, and the bottom surface of the box body covers the groove opening of the waveguide groove to form the waveguide channel.

17. An automobile, comprising a radar, wherein the radar comprises a circuit board, a radio frequency circuit and a waveguide antenna, wherein the waveguide antenna is connected with the radio frequency circuit, and both the waveguide antenna and the radio frequency circuit are arranged on the top of the circuit board;
wherein the waveguide antenna comprises:
a housing, comprising a box body and a cover plate;
a waveguide structure, being arranged between the box body and the cover plate and being configured to transmit signals, the waveguide structure comprising waveguide channels and resonant cavities, wherein one end of each waveguide channel is opened and is arranged at one end of the housing, the other end of each waveguide channel is closed and is connected to a resonant cavity, the waveguide channels comprise waveguide grooves, the waveguide grooves are formed on a bottom surface of the box body facing the cover plate, the cover plate covers groove openings of the waveguide grooves to form the waveguide channels; and
a radiation structure, being arranged on the cover plate and being in communication with the waveguide structure, wherein the radiation structure is configured to transmit and receive signals.

18. The automobile according to claim 17, wherein the waveguide antenna further comprises a transmission line-waveguide transition structure which is arranged at one end of the housing, one end of the transmission line-waveguide transition structure is arranged in the waveguide channel, and the transmission line-waveguide transition structure is configured to mutually convert and propagate signals between the transmission line and the waveguide antenna.

19. The automobile according to claim 18, wherein the transmission line-waveguide transition structure comprises an inclined part, a horizontal part and a protruding part which are sequentially connected, wherein the inclined part and the horizontal part are arranged at an end of the surface of the cover plate facing the box body, the inclined part and the horizontal part are located in the waveguide channel, the protruding part protrudes from the edge of the cover plate, and the protruding part is used for connecting with the transmission line;
the inclined part comprises an inclined plane, and the vertical distance between the inclined plane and the surface of the cover plate increases gradually along the extension direction of the protruding part.

20. The automobile according to claim 17, wherein the radiation structure comprises a radiation aperture and a radiation groove, wherein the radiation aperture is arranged on the surface of the resonant cavity located on the cover plate, the radiation groove is arranged around the radiation aperture, and the radiation groove is arranged on the surface of the cover plate facing away from the box body.
